(19) United States
(12) Patent Application Publication
(10) Pub. No.: US 2008/0005916 A1
(43) Pub. Date: Jan. 10, 2008

(54) DEVICES AND METHODS FOR MEASURING PARAMETERS OF INTERVERTEBRAL DISC SPACE

(76) Inventors: Tom J. Francis, Cordova, TN (US); Randy Allard, Germantown, TN (US); Larry McBride, Ripley, TN (US)

Correspondence Address: HUNTON & WILLIAMS LLP;INTELLECTUAL PROPERTY DEPARTMENT, 1900 K STREET, N.W., SUITE 1200, WASHINGTON, DC, 20006-1109, US

(21) Appl. No.: 11/425,859

(22) Filed: Jun. 22, 2006

(51) Int. Cl. G01B 1/00

(52) U.S. Cl. 33/512

(57) ABSTRACT

Devices for measuring the parameters of an intervertebral disc space are provided. The devices may comprise one or more flexible internal members positioned in an axially concentric bore of a longitudinal element. When activated, the flexible internal member(s) may protrude out of one or more apertures in the longitudinal element and impinge on an adjacent surface of the intervertebral disc space. The device may be useful to determine at least one dimension of an intervertebral disc space.

### FIELD

Embodiments of the invention relate to devices for measuring parameters of an intervertebral disc space. More particularly, embodiments of the invention relate to devices for measuring at least one dimension, for example the height, of an intervertebral disc space.

### BACKGROUND

The intervertebral disc functions to stabilize the spine and to distribute forces between vertebral bodies. The intervertebral disc is composed of three structures: the nucleus pulposus, the annulus fibrosis, and two vertebral end-plates. The nucleus pulposus is an amorphous hydrogel in the center of the intervertebral disc. The annulus fibrosis, which is composed of highly structured collagen fibers, maintains the nucleus pulposus within the center of the intervertebral disc. The vertebral end-plates, composed of hyalin cartilage, separate the disc from adjacent vertebral bodies and act as a transition zone between the hard vertebral bodies and the soft disc.

Intervertebral discs may be displaced or damaged due to trauma, disease, or the normal aging process. One way to treat a displaced or damaged intervertebral disc is by surgical removal of a portion or all of the intervertebral disc, including the nucleus and the annulus fibrosis. However, the removal of the damaged or unhealthy disc may allow the disc space to collapse, which may lead to instability of the spine, abnormal joint mechanics, nerve damage, and severe pain. Therefore, after removal of the disc, a spinal implant such as a prosthetic nucleus, artificial disc, or fusion cage may be implanted in order to replace the removed nucleus or annulus, or a portion thereof.

Because the spinal implant is replacing all or part of the intervertebral disc, it may be desirable to size the spinal implant according to the natural dimensions and geometry of the intervertebral disc that is to be replaced or augmented.

The description herein of problems and disadvantages of known devices and methods is not intended to limit the embodiments disclosed herein to the exclusion of these known entities. Indeed, the embodiments may include one or more of the known devices and methods without suffering from the disadvantages and problems noted herein.

### SUMMARY

There is a need for systems and methods for measuring parameters of an intervertebral disc space. More particularly, there is a need for systems and methods that enable measurements of the intervertebral disc space to be made in a minimally-invasive manner. The embodiments solve some or all of these needs, as well as additional needs.

Therefore, in accordance with an embodiment, there is provided a device for measuring at least one dimension of an intervertebral disc space. The device may comprise a longitudinal element having a longitudinal axis, a coaxially concentric bore, and proximate and distal ends. At least one aperture may be positioned at the distal end of the longitudinal element. An actuator may be positioned at the proximate end of the longitudinal element. Inside of the longitudinal element, a at least one flexible internal member may be disposed. Activating the actuator may cause the flexible internal member(s) to protrude out of the aperture(s) in the longitudinal element.

There also is provided a method of measuring at least one dimension of an intervertebral disc space. The method comprises providing a device having at least one flexible internal member positioned in an axially concentric bore of a longitudinal element, the longitudinal element having at least one aperture positioned at its distal end. The distal end of the device may be inserted into an intervertebral disc space and the device may be activated so that the flexible internal member(s) protrude out of the aperture(s) and contact a surface of the intervertebral disc space. The operator may pause activation when contact between the flexible internal member and a surface of the intervertebral disc space occurs and may determine the at least one dimension based on the extent of the protrusion of the flexible internal member.

There also is provided another method of measuring at least one dimension of an intervertebral disc space. The method may comprise providing a plurality of devices having a flexible internal member positioned in an axially concentric bore of a longitudinal element, the longitudinal element having an aperture positioned at its distal end. Each device may have a different predetermined maximum protrusion distance by which the longitudinal element is capable of protruding out of the aperture when the device is activated. The distal end of the devices may be inserted into an intervertebral disc space sequentially by maximum protrusion distance. When inserted, the device may be activated, deactivated, and then withdrawn. If the plurality of devices is inserted sequentially by distance from smallest to largest, the dimension of the intervertebral disc space may correspond to the predetermined protrusion distance of the first device to impinge a surface of the intervertebral disc space. If the plurality of devices is inserted sequentially by distance from largest to smallest, the dimension of the intervertebral disc space may correspond to the predetermined protrusion distance of the first device that does not impinge a surface of the intervertebral disc space.

These and other features and advantages of the embodiments will be apparent from the description provided herein,

### BRIEF DESCRIPTION OF THE DRAWINGS

FIG. 1 is an illustration of an exemplary device according to the embodiments.

FIG. 2 is an illustration of an exemplary configuration of the longitudinal element and flexible internal member according to the embodiments.

FIG. 3 is an illustration of an exemplary configuration of the longitudinal element and flexible internal member according to the embodiments.

FIG. 4 is an illustration of an exemplary configuration of the longitudinal element and flexible internal member according to the embodiments.

FIG. 5 is an illustration of an exemplary configuration of the longitudinal element and flexible internal member according to the embodiments.

FIG. 6 is an illustration of a device according to the embodiments.

FIG. 7 is an illustration of a device according to the embodiments.

FIG. 8 is an illustration of a device according to the embodiments.

FIG. 9 is an illustration of a device according to the embodiments.

FIG. 10 is an illustration of a device according to the embodiments.

FIG. 11 is an illustration of an exemplary actuator and indicia according to the embodiments.

FIG. 12 is an illustration of a device according to the embodiments.

### DETAILED DESCRIPTION OF THE EMBODIMENTS

The following description is intended to convey a thorough understanding of the various embodiments by providing a number of specific embodiments and details involving devices for measuring the parameters of an intervertebral disc space. It is understood, however, that the embodiments are not limited to these specific embodiments and details, which are exemplary only. It is further understood that one possessing ordinary skill in the art, in light of known systems and methods, would appreciate the use of the embodiments for their intended purposes and benefits in any number of alternative embodiments.

As used throughout this disclosure, the singular forms “a,” “an,” and “the” include plural reference unless the context clearly dictates otherwise.

Throughout this description, the term “intervertebral disc space” may refer to any volume between two adjacent vertebrae. The intervertebral disc space may be the volume inside of the annulus fibrosis of the intervertebral disc. Alternatively, the intervertebral disc space also may include the annulus fibrosis itself The intervertebral disc space may comprise all, or only a portion, of the volume between two adjacent vertebrae.

It is a feature of an embodiment to provide a device for determining at least one dimension of an intervertebral disc space. The device may comprise a longitudinal element having a longitudinal axis, proximate and distal ends, and a coaxially concentric bore. At least one aperture may be positioned at the distal end of the longitudinal element. An actuator may be positioned at the proximate end of the longitudinal element. Inside of the longitudinal element, at least one flexible internal member may be disposed. Activating the actuator may cause the flexible internal member(s) to protrude out of the aperture(s) in the longitudinal element.

The longitudinal element may be any applicable cannula, catheter, trocar, or other hollow or tubular longitudinal element. Preferably, the longitudinal element is dimensioned such that it is easily inserted into an intervertebral disc space. For example, it may be preferred that the longitudinal element have a diameter in the range of from 4 mm to about 6 mm. It also may be preferred that the longitudinal element be about 17 cm to about 23 cm in length. Sizing the longitudinal element within these dimensions may facilitate insertion of the distal end of the longitudinal element into an intervertebral disc space, especially when insertion is carried out by minimally invasive surgical techniques.

The longitudinal element may comprise any appropriate cross section. Therefore, the “diameter” of the longitudinal element may be the diameter of the longitudinal element if it is circular in cross section, or some other dimension if the longitudinal element has a polygonal cross section. In a preferred embodiment, the longitudinal element has a circular cross section. The distal end of the longitudinal element may be open, but preferably is closed, so as to provide a convenient location to attach the flexible internal member disposed inside of the longitudinal element.

The longitudinal element may be manufactured using any appropriate, preferably biocompatible, material. For example, medical plastics such as polyvinyl chlorides, polypropylenes, polystyrenes, acetal copolymers, polyphenyl sulfones, polycarbonates, acrylics, silicone polymers, and mixtures and combinations thereof may be used to manufacture the longitudinal element. Medical alloys such as titanium, titanium alloys, tantalum, tantalum alloys, stainless steel alloys, cobalt-based alloys, cobalt-chromium alloys, cobalt-chromium-molybdenum alloys, niobium alloys, and zirconium alloys also may be used to fabricate the longitudinal element. The longitudinal element preferably may contain struts or guides therein to engage and position the flexible internal member disposed inside of the longitudinal element. One who is skilled in the art will be capable of designing an appropriate longitudinal element, using the guidelines provided herein.

At least one aperture preferably is positioned at the distal end of the longitudinal element. By “positioned at the distal end of the longitudinal element,” it is meant that the aperture is positioned near the distal end of the longitudinal element. The aperture is an opening in the sidewall of the longitudinal element that communicates between the interior and exterior of the longitudinal element. The opening may allow one or more flexible internal members, when placed under a compressive strain, electrical potential, or otherwise actuated, to flex and protrude out of the aperture(s). The aperture may be in any appropriate shape so as to allow the flexible internal member to protrude therefrom. For example, the aperture may be a rectangle, circle, ellipse, square, or some other shape. In the event that two apertures are provided, the apertures preferably are on opposite sides of the distal end of the longitudinal element. Preferably, only a single flexible internal member protrudes out of each aperture.

The flexible internal member may be comprised of any material capable of protruding through the aperture when activated. The term “flexible” is therefore used herein in its broadest sense, and denotes the ability to protrude from the aperture when activated. The flexible internal member therefore may not be flexible when un-activated. Metallic alloys such as stainless steel alloys are a preferred material for fabrication of the flexible internal member. In a preferred embodiment, shape memory alloys are the preferred material for fabrication of the flexible internal member. Shape memory alloys include, but are not limited to, alloys of nickel titanium (“nitinol”), copper-zinc-aluminum, copper-aluminum-nickel, iron-manganese-silicon, silver-cadmium, gold-cadmium, copper-tin, copper-zinc, copper-zinc-silicon, copper-zinc-tin, indium-titanium, nickel-aluminum, iron-platinum, manganese-copper, and iron-manganese-silicon. In another preferred embodiment, the flexible internal member may be fabricated of an appropriate polymer and/or may be in the form of a balloon that can protrude when inflated. Appropriate polymer include, for example, polyurethanes such as thermoplastic polyurethanes, aliphatic polyurethanes, segmented polyurethanes, hydrophilic polyurethanes, polyether-urethane, polycarbonate-urethane, and silicone polyetherurethane. In another embodiment, the flexible internal member may comprise a piezoelectric material such as titanates of barium and lead, lead zirconate, ammonium dihydrogen phosphate, and quartz. Alternatively, the flexible internal member may be a composite of metallic, polymer, or piezoelectric materials. Because the various materials that may comprise the flexible internal member may have different elasticities, the size (i.e., thickness and width) of the flexible internal member may be adjusted in accordance with the material used in order to guarantee that the member is sufficiently flexible.

The actuator may be any appropriate mechanical, electrical, hydraulic, or other device capable of activating the flexible internal member and causing it to flex in response to activation of the actuator so that the flexible internal member protrudes out of the aperture positioned at the distal end of the longitudinal element. For example, a mechanical or hydraulic actuator may place the flexible internal member under a compressive strain such that the flexible internal member flexes and protrudes out of the aperture in the longitudinal element. In another embodiment, an electrical actuator may cause a flexible internal member that is fabricated from at least a piezoelectric material to flex and protrude out of the aperture in the longitudinal element. In a preferred embodiment, the actuator may cause the flexible internal member to protrude out of the aperture such that the distance of the protruding flexible member is between about 3 mm and about 15 mm.

The actuator may take any of a number of different configurations. Some exemplary mechanical configurations are described herein. However, it is to be understood that these configurations are exemplary only and are not meant to limit the form which the actuator make take. One who is skilled in the art will be capable of designing any suitable actuator, using the guidelines provided herein.

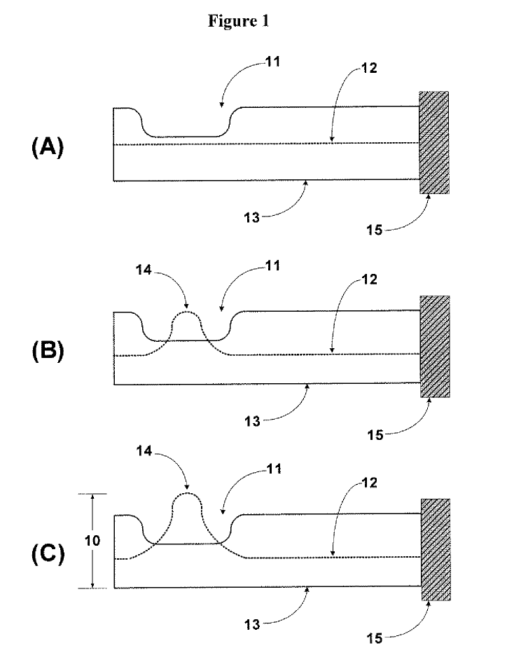

FIG. 1, embodiments A, B, and C, illustrates an exemplary device according to the embodiments. In embodiment A, a flexible internal member 12 is disposed inside of a longitudinal element 13. An aperture 11 positioned at the distal end of the longitudinal element communicates between the interior and exterior of the longitudinal element. An actuator 15 is positioned at the proximate end of the longitudinal element 13. In embodiment B, the actuator 15 has been partially activated to cause a portion of the flexible internal member 14 to flex and protrude out of the aperture 11 in the longitudinal element 13. In embodiment C, the flexible longitudinal element 14 is shown to protrude to an even greater distance as the actuator 15 is more fully activated.

The device preferably may include indicia or some other indicator on the actuator (not shown) calibrated to the distance 10 to which the flexible internal member 14 protrudes. When the protruding portion of the flexible internal member 14 contacts a surface of the intervertebral disc space, further actuation of the flexible internal member 12 may either be prevented or else tactile feedback to the user may indicate that the flexible internal member is in contact with a surface of the intervertebral disc space, thereby allowing the user to determine the distance by which the flexible internal member protrudes. In an alternative embodiment, the capacitance of the flexible internal member may be monitored. The operator may determine when the flexible internal member has contacted a surface of the intervertebral disc space because the capacitance of the flexible internal member may change upon contact with a surface of the disc space.

It may be preferred that the flexible internal member flex only at the aperture in the longitudinal element. In other words, the flexible internal member, when the actuator is activated, preferably will not flex elsewhere in the longitudinal element other than at the aperture. In this way, the actuator may be reliably calibrated to the protrusion distance of the flexible internal member without concern that the flexible internal member is flexing within the longitudinal element itself or elsewhere in the device, which could result in a false measurement.

In order to limit the flexing of the flexible internal member to the aperture in the longitudinal element, it may be preferred that the flexible internal member and the longitudinal element are slidably concentric. That is, it may be preferred that the flexible internal member be in close, slidable contact with the longitudinal element. For example, if the flexible member is rectangular in cross section, then the longitudinal element may preferably be a hollow rectangular member such that the interior surfaces of the longitudinal element are in slidable contact with the surfaces of the flexible internal member. The only area where the flexible internal member will not be fully encapsulated and constrained by the longitudinal element may be at the aperture. When the actuator attempts to cause the flexible internal member to flex, the internal member will be able to do so only at the aperture in the longitudinal element because it is constrained from flexing elsewhere due to its positioning within the longitudinal element. It is to be understood that this same technique may be used with longitudinal elements and flexible internal members having other cross sectional geometries as well.

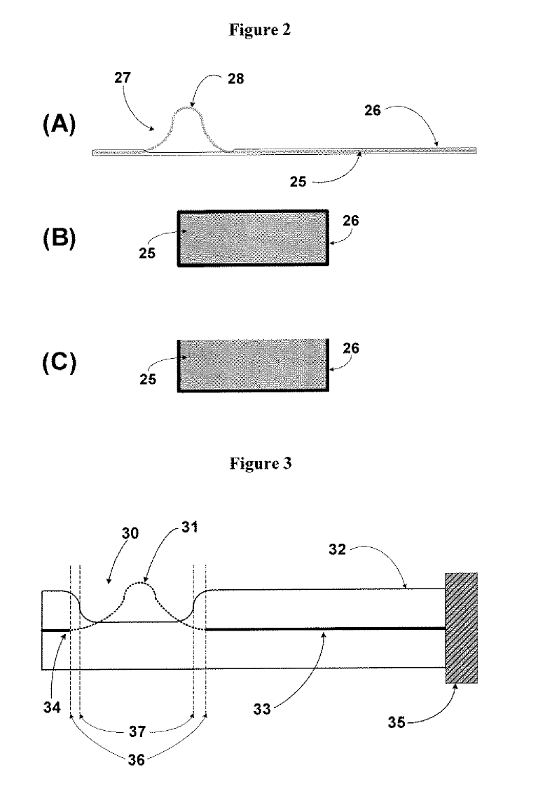

An exemplary configuration of the longitudinal element and flexible internal member wherein the longitudinal element and flexible internal member are slidably concentric is illustrated in FIG. 2, embodiments A, B, and C. In embodiment A, a flexible internal member 25 is slidably concentric with a longitudinal element 26. Because the flexible internal member 25 is in contact with the interior surfaces of the longitudinal element 26 everywhere except at the aperture 27 in the longitudinal element, the flexible internal member is able to flex 28 only at the aperture 27. Embodiment B illustrates the concentricity of the flexible internal member 25 and the longitudinal element 26 at a cross section of the longitudinal element other than at the aperture. Embodiment C is a cross section of the longitudinal element at the aperture, where a portion of the flexible internal member 25 is not restrained by the longitudinal element 26 and therefore may flex or protrude outwards.

In another embodiment, the flexible internal member is positioned only at the aperture within the longitudinal element. By “positioned only at the aperture in the longitudinal element,” it is meant that the ends of the flexible internal member extend no more than about 1 mm to about 10 mm beyond the ends of the aperture. In this embodiment, for example, rigid connectors at either end of the flexible internal member may be used to properly position the flexible internal member within the longitudinal element. By using rigid connectors to position the flexible internal member within the longitudinal element, the flexible internal member need not extend the entire length of the longitudinal element, but only the length of the longitudinal element where the aperture is located. A device according to this embodiment may permit the flexible internal member to flex only at the aperture in the longitudinal element.

An exemplary configuration of the longitudinal element and flexible internal member wherein the flexible internal member is positioned only at the aperture in the longitudinal element is illustrated in FIG. 3. A flexible internal member 31 is positioned only at the aperture 30 in the longitudinal element 32. A rigid connector 34 attaches the flexible internal member 31 to the distal end of the longitudinal element 32. Another rigid connector 33 attaches the flexible internal member 31 to the actuator 35 positioned at the proximate end of the longitudinal element 32. Alternatively, rigid connector 34 may not be utilized in the case where aperture 30 is positioned close enough to the distal end of longitudinal member 32. It is preferred that the ends 36 of the flexible internal member extend no more than about 1 mm to about 10 mm beyond the ends 37 of the aperture 30. Therefore, activation of the flexible internal member 31 may result only in flexing at the aperture 30 in the longitudinal element 32, not elsewhere inside of the device, particularly the longitudinal element.

In another embodiment, the longitudinal element may have “rails” or protrusions extending from the interior surfaces of the longitudinal element. The rails may prevent the flexible internal member from flexing. One or more rails may be absent from the interior surfaces of the longitudinal element at the aperture such that the flexible internal member is not prevented from flexing at the aperture in the longitudinal element. A device according to this embodiment may permit the flexible internal member to flex only at the aperture in the longitudinal element.

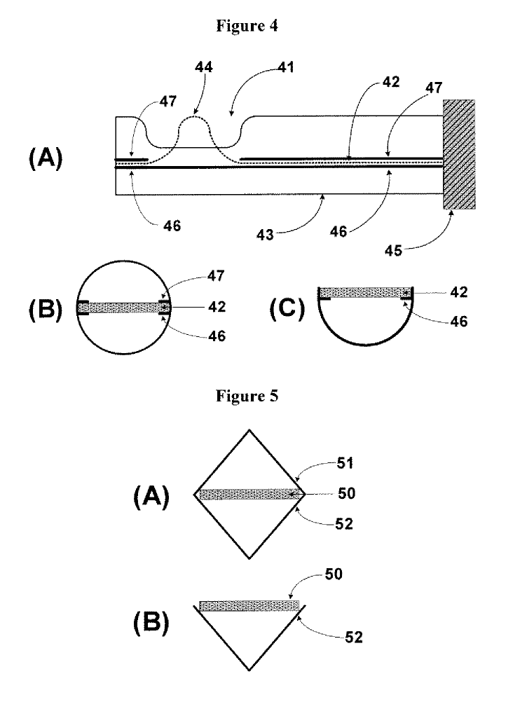

An exemplary configuration of the longitudinal element and flexible internal member wherein rails on the interior surfaces of the longitudinal element prevent the flexible member from flexing except at the aperture is illustrated in FIG. 4, embodiments A, B, and C. A flexible internal member 42 is disposed in a longitudinal element 43 with an aperture 41. An actuator 45 is positioned at the proximate end of the longitudinal element 43. The flexible internal member 42 is located between upper rails 47 and lower rails 46 except at the aperture 41, where the upper rail is absent. Embodiment B is a cross section of the longitudinal element at a position other than at the aperture. As can be seen, the flexible internal member 42 is positioned in between the upper rail 47 and lower rail 46, thereby preventing the flexible internal member from flexing at this point. Embodiment C is a cross section of the longitudinal element at the aperture. As can be seen, the flexible internal member 42 is no longer constrained from flexing upward, though lower rail 46 prevents it from flexing downward. Therefore, activation of the flexible internal member 42 may result only in flexing at the aperture 41 in the longitudinal element 43, not elsewhere inside of the device or the longitudinal element itself.

In another embodiment, the geometries of the longitudinal element and the flexible internal member are such that the flexible internal member can flex only at the aperture in the longitudinal element. Cross sections of an exemplary device of this embodiment are illustrated in FIG. 5, embodiments A and B. In embodiment A, a cross section of the longitudinal element and flexible internal member not at the aperture in the longitudinal element is illustrated. Flexible internal member 50 is disposed inside of the longitudinal element, including upper walls 51 and lower walls 52 is such a manner that it is restricted from flexing. Embodiment B illustrates a cross section of the longitudinal element and flexible internal member at the aperture in the longitudinal element. As can be see, the flexible internal member 50 is not precluded from flexing in an upward direction at the aperture because the upper walls 51 have been removed to provide the aperture. The lower walls 52, however, still prevent the flexible internal member from flexing in a downward direction away from the aperture.

One who is skilled in the art will appreciate still other designs of the longitudinal element and flexible internal member that will restrict flexing of the flexible internal member to the aperture in the longitudinal element, and all such designs are contemplated for use in accordance with the embodiments.

Regardless of the actuator used to activate the flexible internal member, it should be noted that the flexible internal member may be attached directly to the actuator, or the flexible internal member may be attached to the actuator using one or more intermediary structures or linkages. For example, in a preferred embodiment, the flexible internal member may be attached to the actuator using a rigid connector.

The rigid connector, for example, may be coaxially disposed within the longitudinal element and connect the proximate end of the flexible internal member to the actuator. One skilled in the art will appreciate other mechanical, electrical, and electromechanical devices that may be used as intermediary structures to attach or connect the flexible internal member and the actuator.

In a preferred embodiment, the actuator may comprise a handle with an internal hydraulic piston and cylinder connected to an external hydraulic piston and cylinder. Activating the actuator may involve advancing (i.e. pushing or inserting) the external hydraulic piston into the external cylinder, thereby causing the internal hydraulic piston to advance in the internal cylinder. The concerted action of the internal and external hydraulic cylinders may be caused by a hydraulic connection that allows the external cylinder to fluidly communicate with the internal hydraulic piston. The flexible internal member may be connected to the internal hydraulic piston, for example, either directly or by an intermediary structure, such that advancement of the internal hydraulic piston applies a compressive force on the flexible internal member. In response to the compressive force of the advancing internal hydraulic piston, the flexible internal member may flex and protrude out of the aperture in the longitudinal element. In a preferred embodiment, the connecting rod of the external hydraulic piston may be marked with indicia calibrated to the protrusion distance of the flexible internal member. In this way, the operator may determine the protrusion distance of the flexible internal member by examining the position of the indicia on the connecting rod in relation to the external cylinder.

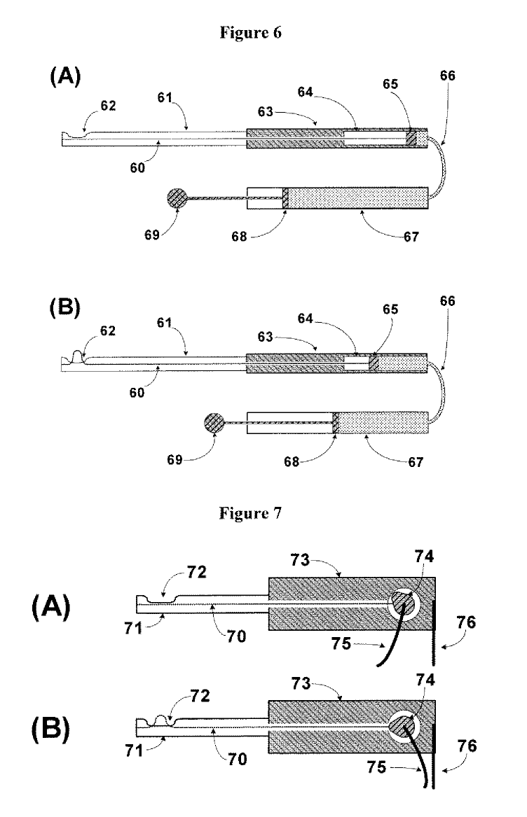

An exemplary actuator comprising a handle having an internal hydraulic piston and cylinder and an external hydraulic piston and cylinder is illustrated in FIG. 6, embodiments A and B. In embodiment A, a flexible internal member 60 is disposed within a longitudinal element 61 with an aperture 62 positioned at the distal end of the longitudinal element. The flexible internal member 60 is connected to a piston 65 disposed within a cylinder 64 internal to the handle 63. Hydraulic tubing 66 connects the internal piston 65 and an external cylinder 67 so that they are in fluid communication. As shown in embodiment B, the actuator may be activated by placing pressure on knob 69, thereby advancing the external piston 68 into the external cylinder 67, which in turn displaces fluid that flows via the tubing 66 and advances the internal piston 65 in the internal cylinder 64. This may apply a compressive force on the flexible internal member 60, causing it to flex and protrude out of the aperture 62.

In another preferred embodiment, the actuator comprises a handle and a cam. The cam may be internal to the handle and connected to a trigger. Activating the actuator may involve rotating the cam by depressing the trigger. The flexible internal member may be connected to the cam, for example, either directly or by an intermediary structure, such that rotation of the cam applies a compressive force on the flexible internal member, which may flex and protrude out of the aperture in the longitudinal element. In a preferred embodiment, the handle may be marked with indicia that correspond to the position of the trigger and are calibrated to the protrusion distance of the flexible internal member. In this way, the operator may determine the distance of the protruding flexible internal member during operation by examination of the position of the trigger in relation to the indicia on the handle.

An exemplary actuator comprising a handle and a cam connected to a trigger is illustrated in FIG. 7, embodiments A and B, A flexible internal member 70 is disposed in a longitudinal element 71 with an aperture 72 positioned at the distal end. A cam 74 is disposed in a handle 73 at the proximate end of the longitudinal element 71. The cam 74 is attached to a trigger 75. Also, an optional palm rest 76 facilitates actuation of the trigger 75. As shown in embodiment B, the actuator is activated by depressing the trigger 75, causing the cam 74 to rotate. The cam 74 applies a compressive force on the flexible internal member 70. In response to the compressive force of the rotating cam, the flexible internal member 70 may flex and protrude out of the aperture 72 in the longitudinal element.

In yet another preferred embodiment, the actuator may comprise a handle and a slidable rod at least partially internal to the handle, Activating the actuator may involve advancing (i.e. pushing or inserting) the slidable rod into the handle. The flexible internal member may be connected to the slidable rod, for example, either directly or by an intermediary structure, such that advancement of the slidable rod into the handle applies a compressive force on the flexible internal member. In response to the compressive force of the advancing rod, the flexible internal member may flex and protrude out of the aperture in the longitudinal element. In a preferred embodiment, the handle and slidable rod may be marked with indicia calibrated to the protrusion distance of the flexible internal member. In this way, the operator may determine the distance of the protruding flexible internal member during operation by examination, for example, of the indicia on the slidable rod.

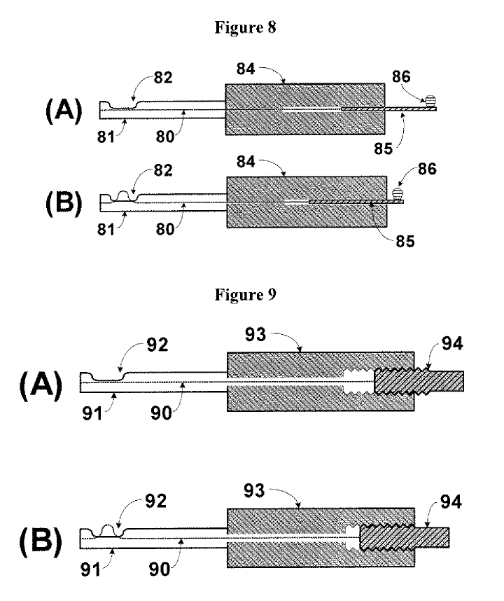

An exemplary actuator comprising a handle and a slidable rod at least partially internal to the handle is illustrated in FIG. 8, embodiments A and B. A flexible internal member 80 is disposed in a longitudinal element 81 with an aperture 82 positioned at the distal end. A handle 84 at the proximate end of the longitudinal element 81 has a slidable rod 85 at least partially internal to the handle. An optional knob 86 is located at the distal end of the slidable rod 85 to facilitate activation. As shown in embodiment B, the actuator is activated by advancing (i.e. pushing or inserting) the slidable rod 85 into the handle 84, thereby applying a compressive force on the flexible internal member 80, which may flex and protrude out of the aperture 82 in the longitudinal element 81.

In still another preferred embodiment, the actuator may comprise an internally threaded handle threadably engageable with an externally threaded dial. Activating the actuator may involve advancing the dial into the handle by turning the dial. The flexible internal member may be connected to the dial, for example, either directly or by an intermediary structure, such that advancement of the dial may apply a compressive force against the flexible internal member. In response to the compressive force of the advancing dial, the flexible internal member may flex and protrude out of the aperture in the longitudinal element. In a preferred embodiment, the dial and handle may be marked with indicia calibrated to the protrusion distance of the flexible internal member. In this way, the operator may determine the distance of the protruding flexible internal member during operation.

An exemplary actuator comprising a handle tapped to accept a threaded dial is illustrated in FIG. 9, embodiments A and B. A flexible internal member 90 is disposed in a longitudinal element 91 with an aperture 92 positioned at the distal end. A handle 93 at the proximate end of the longitudinal element 91 is tapped to accept a threaded dial 94. As shown in embodiment B, activation of the actuator comprises advancing (i.e. rotating) the threaded dial 94 into the tapped handle 93. Activation of the actuator applies a compressive force to the flexible internal member 90, causing it to flex and protrude out of the aperture 92.

The actuator in another preferred embodiment may comprise a handle having an axially concentric bore and a plunger capable of being inserted into the axially concentric bore. Activating the actuator may involve inserting the plunger into the bore. The flexible internal member may be connected to the plunger, for example, either directly or by an intermediary structure, such that advancement of the plunger into the handle may apply a compressive force against the flexible internal member. In response to the compressive force of the advancing plunger, the flexible internal member may flex and protrude out of the aperture in the longitudinal element. In a preferred embodiment, the plunger may be marked with indicia calibrated to the protrusion distance of the flexible internal member. In this way, the operator may determine the distance of the protruding flexible internal member during operation.

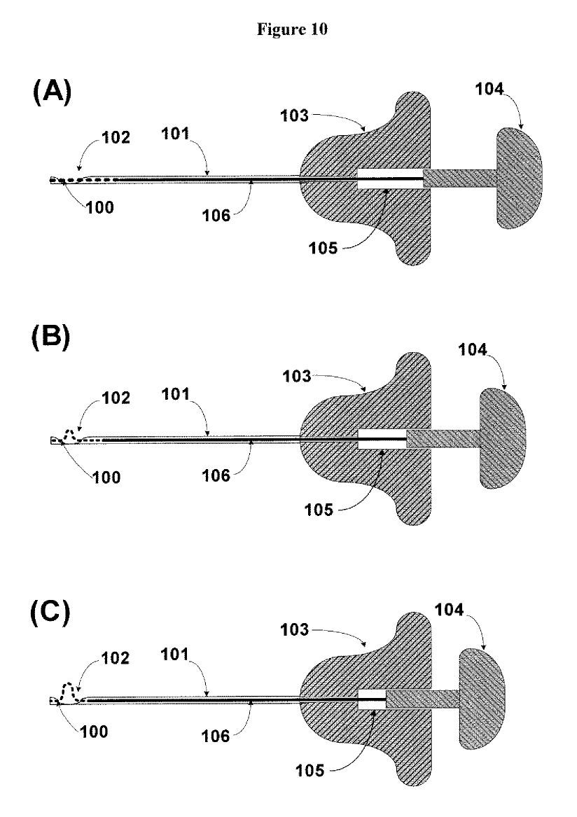

An exemplary actuator comprising a handle and a plunger is illustrated in FIG. 10, embodiments A, B, and C. A flexible internal member 100 is disposed in a longitudinal element 101 with an aperture 102 positioned at the distal end. As seen, the outer diameter of the flexible internal member 100 nearly matches the internal diameter of the longitudinal element 101; this may help to prevent the flexible internal member from binding up inside of the longitudinal element. The flexible internal member is connected to a rigid connector 106. The outer diameter of the rigid connector 106 also nearly matches the internal diameter of the longitudinal element 101, again to help to prevent the rigid connector from binding up inside of the longitudinal element. Also, the use of the rigid connector 106 helps to prevent flexing of the flexible internal member 100 at locations other than at the aperture 102.

A handle 103 is located at the proximate end of the longitudinal element 101. A plunger 104 may be inserted into an axially concentric bore 105 in the handle 103 and is connected to the rigid connector 106. As shown in embodiment B, activation of the actuator comprises inserting (i.e. advancing or slidably disposing) the plunger 104 into the handle 103. Activation of the actuator applies a compressive force to the flexible internal member via the rigid connector 106, causing flexible internal member to protrude 100 at the aperture 102. As shown in embodiment C, the protrusion distance 100 of the internal flexible member increases as the plunger 104 is further inserted into the handle 103.

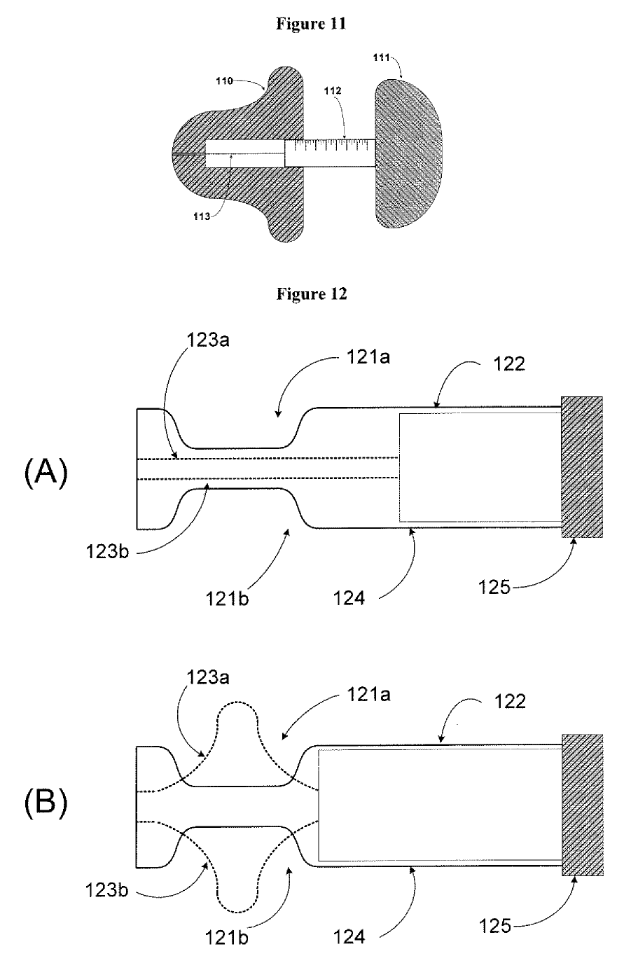

FIG. 11 illustrates exemplary indicia that may be used to determine the protrusion distance of the flexible internal member when actuated. A handle 110 and plunger 111 are slidably disposable and the plunger 111 is connected to the flexible internal member 113. Indicia 112 on the plunger 111 may be calibrated to the protrusion distance of the flexible internal member.

A preferred embodiment of the invention is depicted in FIG. 12. In embodiment A of FIG. 12, a longitudinal element 124 is provided with an actuator mechanism 125 at its proximate end. A piston 122 is slidably diposed in the longitudinal element 124. When the actuator mechanism is operated, the piston 122 is forced towards the distal end of the longitudinal element 124, thus compressing two flexible internal members or spring tamps 123a and 123b (or one flexible internal member connected at its distal-most end, and split into two flexible members at or near the apertures 121a, 121b, and either remaining as two flexible members, or being rejoined at a more proximal end near piston 122). The spring tamps 123a and 123b flex and protrude out of apertures 121a and 121b that are positioned at the distal end of the longitudinal element 124 and on opposite sides of the longitudinal element. Embodiment B of FIG. 12 shows the spring tamps 123a and 123b protruding out of the apertures 121a and 121b.

Alternatively, the flexible internal member may be a balloon-type member. The actuator may comprise a fluid reservoir in fluid communication with the balloon-type member. Actuating the actuator may cause a fluid (e.g., liquid or air) to be displaced from the fluid reservoir and fill the balloon-type flexible internal member, causing it to protrude at the aperture. This alternative embodiment can be used with any of the actuators disclosed herein.

In still another exemplary embodiment, the actuator may be an electric power source such as a battery. In this embodiment, the flexible internal member comprises at least a piezoelectric material, optionally in combination with layers of other metals or polymers. When the actuator is actuated, an electric potential is applied across the flexible internal member, causing the piezoelectric material therein to flex and the flexible internal member to protrude out the aperture positioned at the distal end of the longitudinal element. By calibrating the potential required to achieve a given protrusion distance of the flexible internal member, the device may be used to determine a dimension of an intervertebral disc space. Because such a device may not provide tactile feedback to the operator by which it can be determined if the flexible internal member is in contact with a surface of the intervertebral disc space, it may be preferable to monitor the capacitance of the flexible internal member during use. The operator may thereby determine when the flexible internal member has contacted a surface of the intervertebral disc space because the capacitance of the flexible internal member may change upon contact with a surface of the intervertebral disc space.

It should be noted that the actuators described herein are exemplary and that other actuators are contemplated for use in the embodiments, in keeping with the limitations described herein.

In another embodiment, there is provided a method of measuring at least one dimension of an intervertebral disc space. The method comprises providing a device having a flexible internal member positioned in an axially concentric bore of a longitudinal element, the longitudinal element having an aperture positioned at its distal end. The distal end of the device may be inserted into an intervertebral disc space and the device may be activated so that the flexible internal member protrudes out of the aperture and contacts a surface of the intervertebral disc space. The operator may pause activation when contact between the flexible internal member and a surface of the intervertebral disc space occurs and may determine the at least one dimension based on the extent of the protrusion of the flexible internal member.

Following determination of the dimension, the device may be deactivated and removed from the intervertebral disc space. Deactivation of the actuator may result in the flexible internal member receding into the aperture positioned at the distal end of the device. In this way, the flexible internal member will not be an impediment to removing the device from the intervertebral disc space. In a preferred embodiment, inserting and removing the device from the intervertebral disc space may be carried out by minimally invasive surgical techniques.

The operator may pause activation when the flexible internal member contacts a surface of the intervertebral disc. In a preferred embodiment, impingement of the flexible internal member on a surface of the intervertebral disc space provides tactile feedback to the operator, informing the operator that the flexible internal member is in contact with a surface of the intervertebral disc space, and consequently cannot protrude any further. In another preferred embodiment, the capacitance of the flexible internal member is monitored during operation. A change in capacitance of the flexible internal member may inform the operator that the flexible internal member is in contact with a surface of the intervertebral disc space.

There also is provided another method of measuring at least one dimension of an intervertebral disc space. The method may comprise providing a plurality of devices having a flexible internal member positioned in an axially concentric bore of a longitudinal element, the longitudinal element having an aperture positioned at its distal end. Each device may have a different predetermined maximum protrusion distance by which the longitudinal element is capable of protruding out of the aperture when the device is activated. The distal end of the devices may be inserted into an intervertebral disc space sequentially by maximum protrusion distance. When inserted, the device may be activated, deactivated, and then withdrawn. If the plurality of devices is inserted sequentially by distance from smallest to largest, the dimension of the intervertebral disc space may correspond to the predetermined protrusion distance of the first device to impinge a surface of the intervertebral disc space. If the plurality of devices is inserted sequentially by distance from largest to smallest, the dimension of the intervertebral disc space may correspond to the predetermined protrusion distance of the first device that does not impinge a surface of the intervertebral disc space.

The methods of the embodiments may allow a dimension of the intervertebral disc space to be determined within a specific range or within certain tolerances. For example, when a device is found that contacts a surface of the intervertebral disc space (starting from smallest to largest), or a device is found that does not contact the intervertebral disc space (starting from largest to smallest), the dimension of the intervertebral disc space that is being measured, for example the height, may be considered to be the predetermined protrusion distance of that device. For example, if a 14 mm, then 12 mm, then 10 mm device is inserted and activated, and the 10 mm device is the first to contact a surface of the intervertebral disc space, then the dimension can be considered to be about 10 mm. Alternatively, the dimension can be considered to be about 11 mm, ±1 mm, because the dimension is somewhere between 12 mm and 10 mm. In another alternative, the dimension can be considered to be in the range of from about 10 mm to about 12 mm. One who is skilled in the art will appreciate that this same methodology and reasoning can be used for any set of devices having different predetermined protrusion distances.

In a preferred embodiment, as is exemplarily illustrated in FIG. 1, the distance of the protruding flexible internal member 10 of the plurality of devices used to determine at least one dimension of an intervertebral disc space is about 6 mm, about 8 mm, about 10 mm, about 12 mm, and about 14 mm.

The devices and methods of the embodiments may be advantageously used to determine the dimension (e.g., height, width, volume, wedge angle, etc.) of an intervertebral disc space prior to implantation of a spinal implant to replace all or part of the nucleus and annulus of the intervertebral disc. Spinal implants include, for example, a fusion cage, artificial disc, or prosthetic disc nucleus. A snug fit between the spinal implant and the intervertebral disc space is thought to be desirable because of the reduced possibility of implant rotation, reduced possibility of excessive implant movement inside the disc space, increased contact between the vertebral end plates and implant, and increased annulus tension. Therefore, a correctly sized spinal implant may be more likely to achieve a desirable clinical result than would be an incorrectly sized implant.

Preferably, the height of the intervertebral disc space may be measured using devices and methods according to the embodiments. Measuring the height of the intervertebral disc space may include measuring the anterior, middle, and posterior height of the disc space, as these three measurements may differ, even in the same intervertebral disc space. Additionally, the wedge angle of the intervertebral disc space may be calculated from the anterior, middle, and posterior height of the disc space. Determination of the height of the disc space may enable customization and sizing of the spinal implant to the individual patient.

In another embodiment, excess tissue may be removed before implantation of the spinal implant. Because spinal implants often are manufactured pre-surgery, it may be necessary to shape the intervertebral disc space to fit the implant that it is be implanted. Measuring the height of the intervertebral disc space therefore may enable a surgeon to determine what if any, excess tissue should be removed prior to implantation of the spinal implant. This may lead to a closer correlation in size between the intervertebral disc space and the spinal implant, and a more desirable clinical outcome.

The foregoing detailed description is provided to describe the embodiments in detail, and is not intended to limit the embodiments. Those skilled in the art will appreciate that various modifications may be made to the embodiments without departing significantly from the spirit and scope thereof

What is claimed is:

1. A device for measuring at least one dimension of an intervertebral disc space, comprising:
a longitudinal element having a longitudinal axis, a coaxially concentric bore, distal and proximate ends, and at least one aperture positioned at its distal end;
an actuator mechanism positioned at the proximate end of the longitudinal element; and
at least one flexible internal member disposed within the coaxially concentric bore of the longitudinal element;
wherein activating the actuator mechanism causes each flexible internal member to protrude out of an aperture.

2. The device of claim 1, wherein the flexible internal members protrude out of the apertures in the longitudinal element by a distance of between about 3 millimeters and about 15 millimeters.

3. The device of claim 1, further comprising a gauge capable of visually displaying the distance by which the longitudinal elements are protruding out of the apertures.

4. The device of claim 17 wherein the flexible internal members are able to flex only at the apertures in the longitudinal element.

5. The device of claim 1, wherein activating the actuator mechanism applies a compressive force to the flexible internal members.

6. The device of claim 5, wherein the compressive force is applied to the flexible internal members by motion of a piston positioned in the longitudinal element's bore, the piston connecting the actuator mechanism to the flexible internal members.

7. The device of claim 1, wherein the device comprises two apertures, each of which is on an opposite side of the distal end of the longtudinal element.

8. The device of claim 7, further comprising two flexible internal members, and wherein activating the actuator mechanism causes each of the flexible internal members to protrude out of a respective aperture.

9. The device of claim 1, wherein the device comprises one aperture and one flexible internal member, and wherein activating the actuator mechanism causes the flexible internal member to protrude out of the aperture.

10. The device of claim 1, wherein the actuator mechanism comprises a handle having an axially concentric bore and a plunger capable of being inserted into the handle's axially concentric bore, and wherein actuating the actuator comprises pressing the plunger into the handle's axially concentric bore.

11. A method of measuring at least one dimension of an intervertebral disc space, comprising:
providing a device having at least one flexible internal member positioned in an axially concentric bore of a longitudinal element, the longitudinal element having at least one aperture positioned at its distal end;
inserting at least the distal end of the longitudinal element into an intervertebral disc space;
activating the device so that the flexible internal members protrude out of the apertures;
pausing activation when the flexible internal members impinge on a surface of the intervertebral disc space; and
determining the at least one dimension of the intervertebral disc space based on the extent of the protrusion of the flexible internal members from the apertures.

12. The method of claim 11, further comprising:
deactivating the device; and,
removing the device from the intervertebral disc space.

13. The method of claim 12, wherein inserting and removing the device from the intervertebral disc space is carried out by minimally invasive surgical techniques.

14. The method of claim 11, wherein impingement of the flexible internal members on a surface of the intervertebral disc space provides tactile feedback to the operator to inform the operator that the flexible internal members are in contact with a surface of the intervertebral disc.

15. A method of measuring at least one dimension of an intervertebral disc space, comprising:
providing a plurality of devices having a flexible internal member positioned in an axially concentric bore of a longitudinal element, the longitudinal element having an aperture positioned at its distal end, and each device having a different predetermined maximum protrusion distance by which the longitudinal element is capable of protruding out of the aperture when the device is activated; and
sequentially by maximum protrusion distance inserting the distal end of a device into the intervertebral disc space, activating the device, deactivating the devices and removing the device;
wherein, if the plurality of devices is inserted sequentially by distance from smallest to largest, the dimension of the intervertebral disc space corresponds to the predetermined protrusion distance of the first device to impinge a surface of the intervertebral disc space, and if the plurality of devices is inserted sequentially by distance from largest to smallest, the dimension of the intervertebral disc space corresponds to the predetermined protrusion distance of the first device that cannot impinge a surface of the intervertebral disc space.
